(19) United States
(12) Patent Application Publication
(10) Pub. No.: US 2012/0143779 A1
(43) Pub. Date: Jun. 7, 2012

(54) ONLINE MATCHMAKING SYSTEM AND METHOD

(75) Inventor: Chia-Ming CHANG, Taipei City (TW)

(73) Assignee: Sunfun Info Co., Ltd.

(21) Appl. No.: 13/083,371

(22) Filed: Apr. 8, 2011

(30) Foreign Application Priority Data
Dec. 3, 2010 (TW) 099142124

(51) Int. Cl. G06Q 99/00

(52) U.S. Cl. 705/319

(57) ABSTRACT

An online matchmaking management system includes a member database for storing a plurality of member data files, an account management module configured to process login data of a user, and a matching module configured to receive a matching condition and to select at least one candidate member. The online matchmaking management system also includes an interaction module configured to provide an interaction interface for the user to generate a marriage suitability questionnaire, to provide the marriage suitability questionnaire to a target member selected by the user from the at least one candidate member, to relay to the user response of the target member to the marriage suitability questionnaire, and based on a number of interactions between the user and the target member, to provide the user with conditional authorization for further interaction with the target member.

### CROSS-REFERENCE TO RELATED APPLICATION

This application claims priority to Taiwanese application no. 099142124, filed on Dec. 3, 2010.

### BACKGROUND OF THE INVENTION

1. Field of the Invention

The invention relates to a system and method for matchmaking, and more particularly to an online matchmaking system and method.

2. Description of the Related Art

According to statistical data provided by the Department of Internal Ministry of the Republic of China in 2008, thirty percent of women within the age of marriage are unmarried. The approximate marriage rate of couples formed per thousand persons of a population has dropped from 9+ couples twenty years ago to 5+ couples per thousand in recent times.

Some possible causes for later marriage include: (1) the reduction of outdoor activities as the result of more frequent web surfing, TV watching, electronic game playing, etc. at home; and (2) the reduction of human interactions given increasing time demands and pressure from modern occupations.

Online dating provides one option for potential couples to meet, but the lack of screening may allow fraud to occur. Conventional matchmaking services, on the other hand, may require a high initial charge to pay for a manual search through membership records. Such matchmaking services may be subjective, time consuming, and wasteful in terms of labor and cost.

As such, it is highly desired to develop an online matchmaking system and method that addresses the disadvantages of the above methods.

### SUMMARY OF THE INVENTION

An object of the present invention is to provide a safe, convenient, and efficient medium for all members that desire marriage to form matches quickly and smoothly.

An online matchmaking system according to the present invention includes a member database for storing a plurality of member data files, each including basic data of a member. The online matchmaking system further includes an account management module connected to the member database and configured to process login data of a user. The online matchmaking management system also includes a matching module connected to the member database. The matching module is configured to receive a matching condition established by the user, and to select at least one candidate member from the member database that satisfies the matching condition. The online matchmaking management system also includes an interaction module connected to the matching module and configured to provide an interaction interface for the user to generate a marriage suitability questionnaire, to provide the marriage suitability questionnaire to a target member selected by the user from the at least one candidate member, to relay to the user the response of the target member to the marriage suitability questionnaire, and based on a number of interactions between the user and the target member, to provide the user with conditional authorization for further interaction with the target member.

This invention provides a more favorable service for those who intend to get married. Some aspects of this invention include receiving matching conditions of a user to quickly find candidate members, providing interaction between members through questionnaires to permit a potential couple to develop mutual understanding, and using conditional authorization for interaction between members as a mechanism to reduce dating costs.

### BRIEF DESCRIPTION OF THE DRAWINGS

Other features and advantages of the present invention will become apparent in the following detailed description of the preferred embodiment with reference to the accompanying drawings, of which:

FIG. 1 is a system block diagram of the preferred embodiment of an online matchmaking system according to the present invention;

FIG. 2 is a flowchart of the preferred embodiment of an online matchmaking method according to the present invention;

FIG. 3 is a more detailed flowchart of step S3 of the flowchart in FIG. 2; and

FIGS. 4 to 10 illustrate user interfaces for executing the steps of the preferred embodiment.

### DETAILED DESCRIPTION OF THE PREFERRED EMBODIMENT

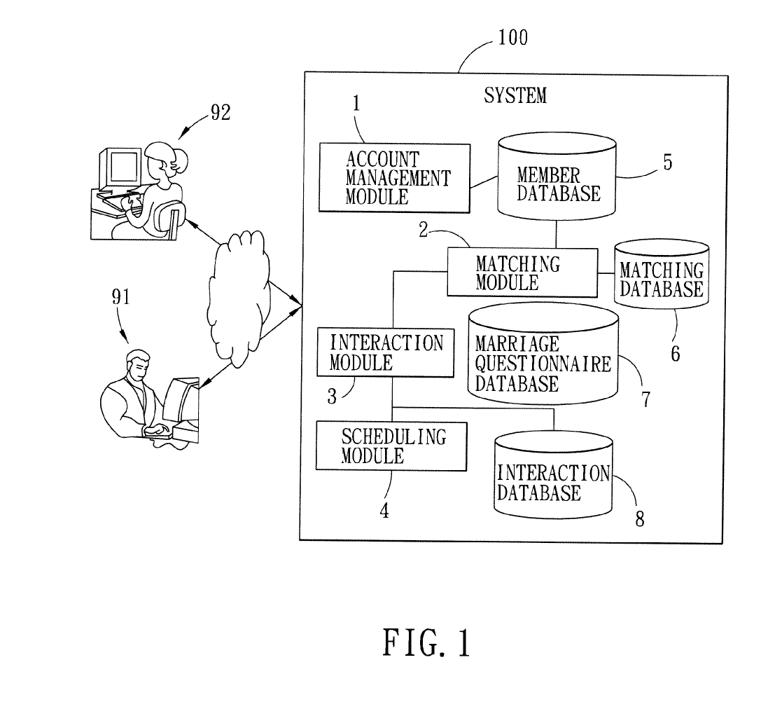

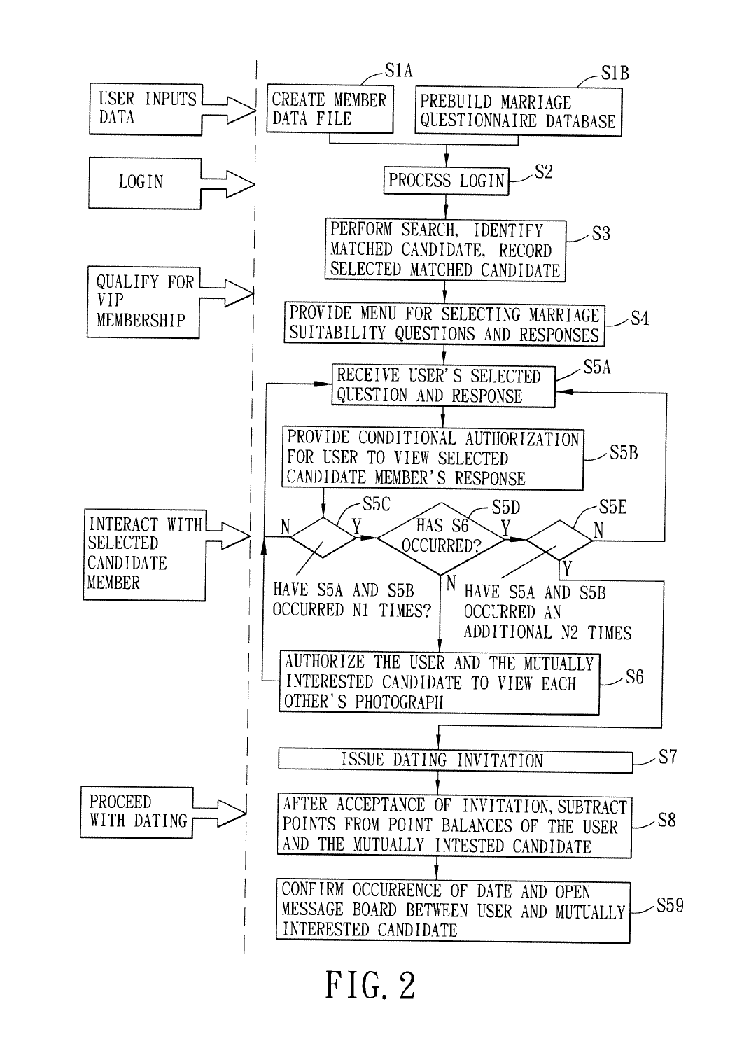

As shown in FIGS. 1 and 2, the preferred embodiment of a system 100 for online matchmaking management according to the present invention is shown to be established on at least one server for providing service to a plurality of users, each establishing connection with the server over a network using an electronic device. The system 100 is used to match the users. In the description below, an example is given to illustrate that a user 91 is smoothly matched with another user 92 using the system 100.

The system 100 comprises an account management module 1, a matching module 2, an interaction module 3, a scheduling module 4, a member database 5, a matching database 6, a marriage questionnaire database 7 and an interaction database 8. The member database 5 and the marriage questionnaire database 7 are prebuilt, dynamically updated, and shared by all members. The member database 5 stores a plurality of member data files. The matching database 6 and the interaction database 8 are dedicated to each user (who must be registered as a member first). In implementation, the matching database 6 and the interaction database 8 may be stored with the corresponding member data file.

The account management module 1 and the matching module 2 are connected to the member database 5, and the interaction module 3 is connected to the matching module 2, the marriage questionnaire database 7 and the interaction database 8. The scheduling module 4 is connected to the interaction module 3.

The matching module 2 is configured to receive a matching condition established by the user 91, and to select at least one candidate member from the member database 5 that satisfies the matching condition.

When the user 91 selects the target member from the one or more candidate members selected by the matching module 2, the matching module 2 presents the basic data of the target member to the user 91 through the interaction module 3 and asks whether the user 91 is interested in the target member. Upon receipt of an indication of interest of the user 91 in the target member, the matching module 2 issues a notification to the target member of someone's interest and asks the target member whether the target member is interested in further interaction. Upon receipt of an indication of the target member's interest in further interaction, the matching module 2 records the target member in the matching file of the user 91, and instructs the interaction module 3 to provide an interaction interface to the user 91.

The interaction module 3 is configured to provide the interaction interface for the user 91 to generate a marriage suitability questionnaire, to provide the marriage suitability questionnaire to a target member selected by the user 91 from the one or more candidate members, to relay to the user 91 the response of the target member to the marriage suitability questionnaire, and based on a number of interactions between the user 91 and the target member, to provide the user 91 with conditional authorization for further interaction with the target member. The marriage questionnaire database 7 is used for storing a plurality of questions about marriage suitability for the marriage suitability questionnaire.

The interaction interface provided by the interaction module 3 includes a menu containing the questions about marriage suitability for selection by the user. The interaction interface provided by the interaction module 3 further includes a plurality of response fields corresponding respectively to the questions about marriage suitability for the user 91 to fill in a user reply when the respective one of the questions is selected by the user 91. The user reply is provided to the target member when the interaction module 3 receives from the target member a target member reply to the respective one of the questions.

The account management module 1 subtracts a predetermined number of points from a point balance of the member data file corresponding to the user 91 upon receipt of an indication that the user 91 wishes to be provided with the response of the target member to the questions selected by the user.

When the interaction module 3 determines that the number of interactions between the user 91 and the target member has reached a predetermined number, the scheduling module 4 issues a dating invitation for the user 91 and the target member to go out on a date. When the dating invitation is accepted by both the user 91 and the target member, the scheduling module 4 enables the account management module 1 to subtract a number of points from the point balance of the member data file corresponding to at least one of the user 91 and the target member.

With the users 91, 92, the system 100 is operable to execute the process flow shown in FIG. 2. In FIG. 2, the computer operations performed by the user 91 are shown at the left of a dotted line, and the steps executed by the system 100 are shown at the right of the dotted line. The operations performed by the system 100 include the following:

Step S1a—the account management module 1 of the system 100 creates a member data file to be stored in the member database 5. Each of the member data files includes the basic data of the corresponding user and a point balance managed by the account management module 1. In this embodiment, the user 91 is initially registered as an ordinary member. To register, the user 91 inputs his basic data, his current occupation status, his academic records, his family background, his economic status, his self-introduction, his photos, his conditions for choosing a spouse, etc. into the system 100. For protection of the members and promotion of the system's authenticity, the account management module 1 processes authentication of at least one of a mobile phone number, an email address, biometric data, an ID card, and an academic certificate for each of the member data files.

Step S1b—the system 100 prebuilds the marriage questionnaire database 7, which is capable of accepting additional data from the users 91,92.

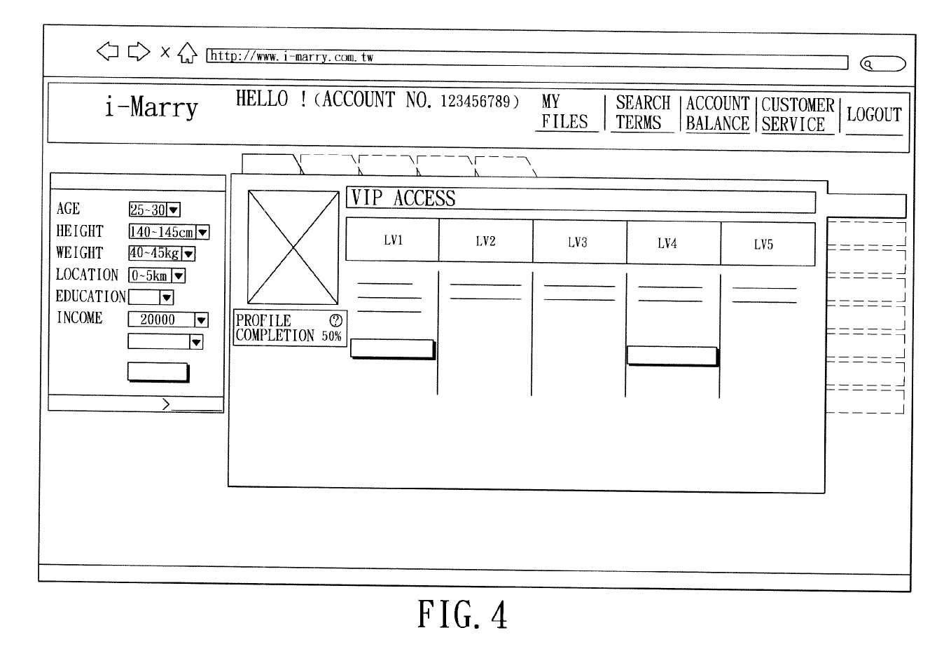

Step S2—when the user 91 completes the registration, he may log in to use the system 100. When the account management module 1 processes the login information of the user 91, the account management module 1 provides the user 91 with an interaction interface as shown in FIG. 4.

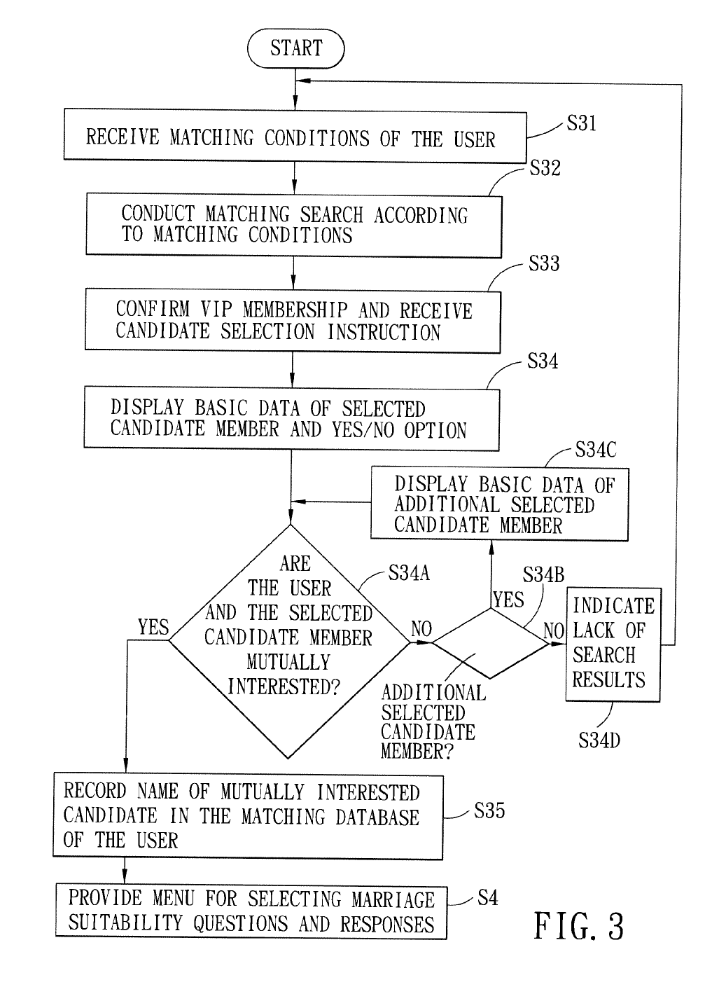

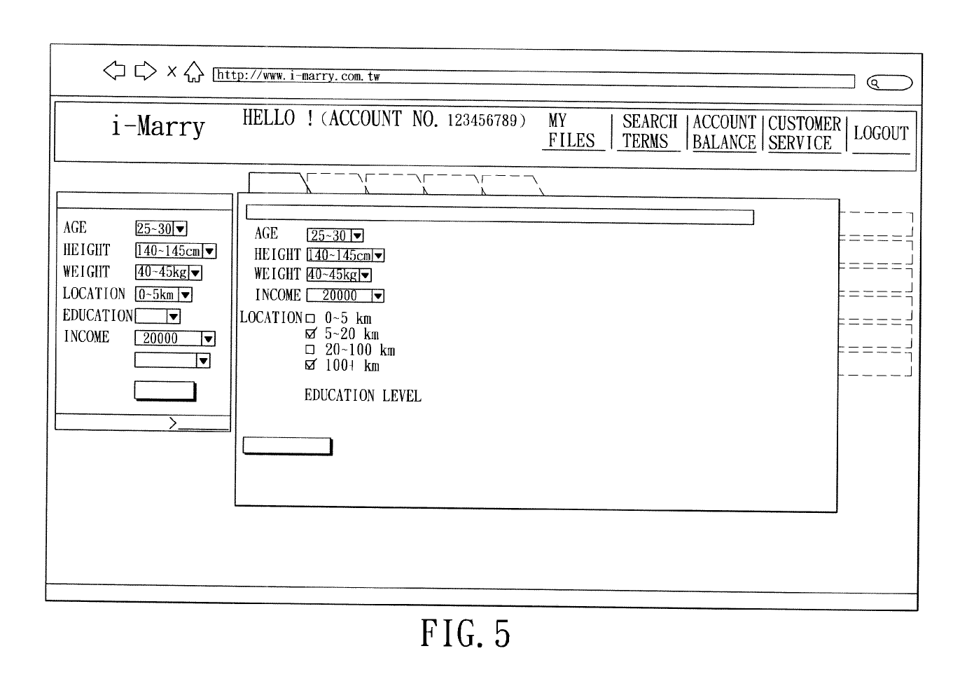

Step S3—when the user 91 proceeds, the user 91 is presented with the interaction interface shown in FIG. 5. The user 91 can then select from options for quick search (basic data search), an advanced search (which permits configurable search options), newest member, occupation, etc. The user 91 can therefore determine matching conditions. More detailed steps executed by the matching module 2 in the present embodiment are shown in FIG. 3.

Step S31—the matching conditions established by the user 91 are received.

Step S32—matching search is conducted according to the matching conditions, and at least one candidate member who satisfies the matching condition is identified from the member database 5 as a matched candidate. In this embodiment, a plurality of matched candidates are identified.

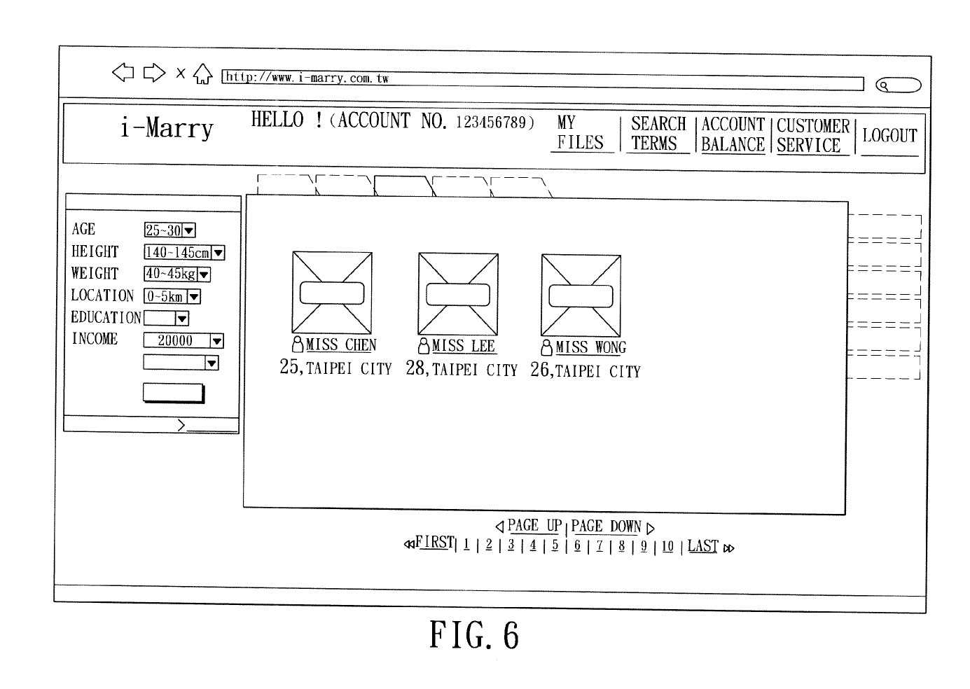

Step S33—the names of the candidate members are listed in a table as shown in FIG. 6. Before selecting from the matched candidates, such as user 92, user 91 must purchase and spend sufficient points to qualify for a VIP membership. The matching module 2 of the system 100 can then be enabled to receive a candidate selection instruction for the process flow to proceed to step S34. Otherwise, the screen of FIG. 6 remains.

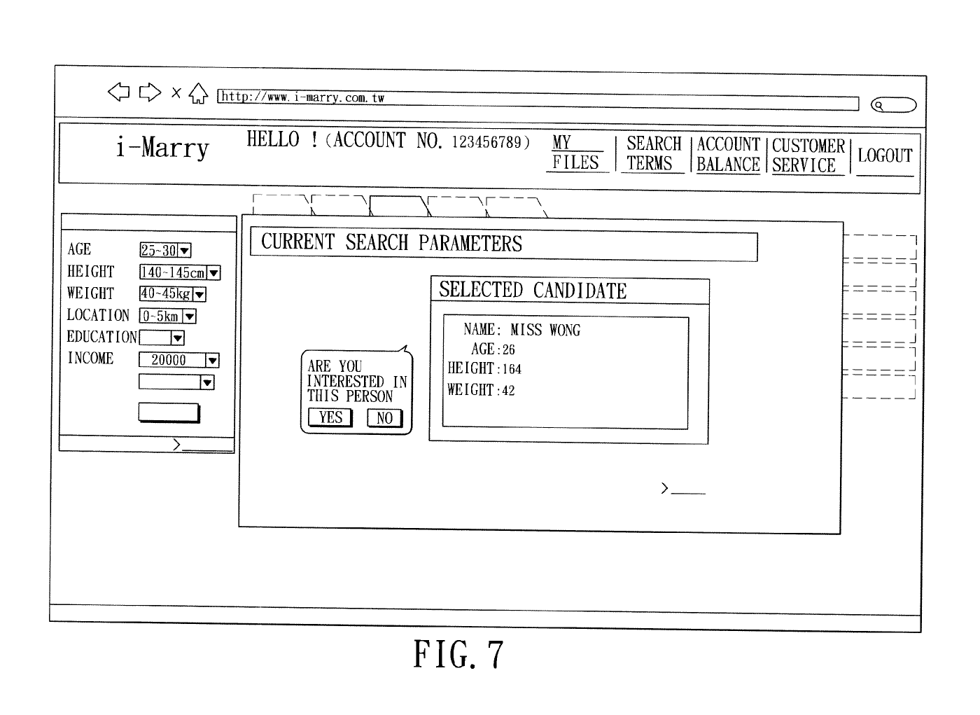

Step S34—in FIG. 7, a dialog box is illustrated that includes the basic data of the selected candidate member (e.g., the user 92) and a YES/NO option for the user 91 to indicate interest in the user 92. If the user 91 selects YES, the matching module 2 receives the corresponding instruction and notifies the user 92 that someone is interested in her. If the matching module 2 receives the reply of the user 92 that shows she is also interested in the user 91, the process flow goes to step S35. If the user 91 selects NO and another selected matched candidate exists, the basic data of the next one of the selected matched candidates is shown.

Step S35—the name of the user 92 is recorded in the matching database 6 corresponding to the user 91. After step S35, the process continues with step S4 of the flowchart shown in FIG. 2.

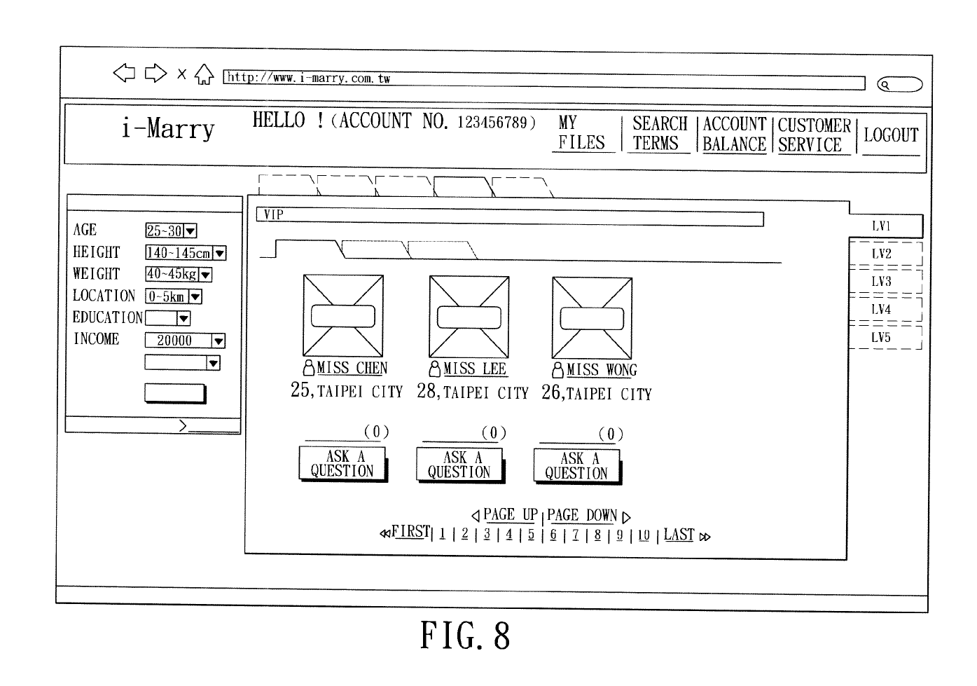

Step S4—in this operation, the user 91 may become better acquainted with the user 92. As shown in FIG. 8, the interaction module 3 provides an option to create a marriage suitability questionnaire.

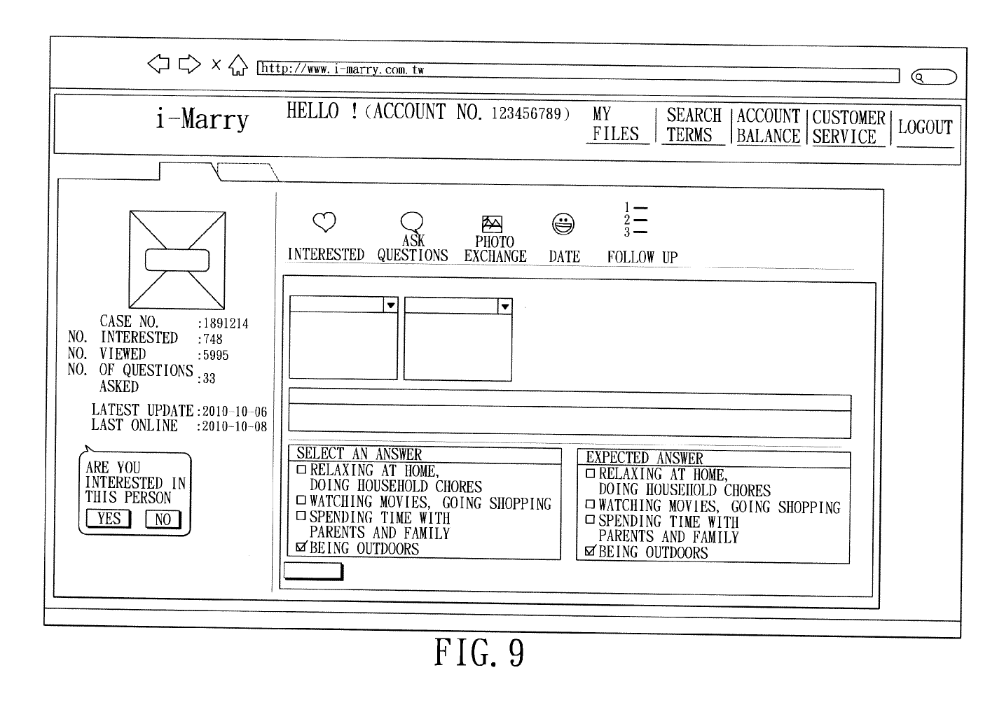

Step S5a—when the user intends to ask the user 92 a question, he selects the option to “ask her a question.” As shown in FIG. 9, a menu is presented with a plurality of questions and possible replies, which permits the user 91 to select the marriage suitability question to ask the user 92 and to enter his own reply to the same marriage suitability question. The interaction module 3 receives the selected marriage suitability question and the user's 91 response, and sends the selected marriage suitability question to the user 92.

Step S5b—when the user 92 is logged into the system 100, the system 100 provides the user 92 with the marriage suitability question selected by the interested member (e.g., user 91). If the user 92 answers the question, the interaction module 3 receives the user's 92 reply and notifies the user 91 that the marriage suitability question was answered.

To proceed with further interaction with the target member (e.g., user 92), the user 91 is asked to satisfy a condition. In this embodiment, the condition is an agreement to have a specified number of points deducted from the point balance of the user 91. After the user 91 agrees to pay a specified number of points, the interaction module 3 notifies the account management module 3 of the user's agreement, and the account management module 3 deducts the specified number of points from the user 91's point balance. The interaction module 3 then authorizes the user 91 and the user 92 to see each other's replies to the selected marriage suitability question.

Step S5C—if S5A and S5B have not occurred a designated number (N1) of times (e.g., after a designated number of interactions have been performed), the process returns to S5A. If N1 has been reached, the process continues to SSD.

Step S5D—if Step S6 has not yet occurred, the process continues to step S6. If S6 has occurred, the process continues to step S5E.

Step S5E—if S5A and S5B have not occurred an additional designated number (N2) of times, the process returns to S5A. If N2 has been reached, the process continues to S7.

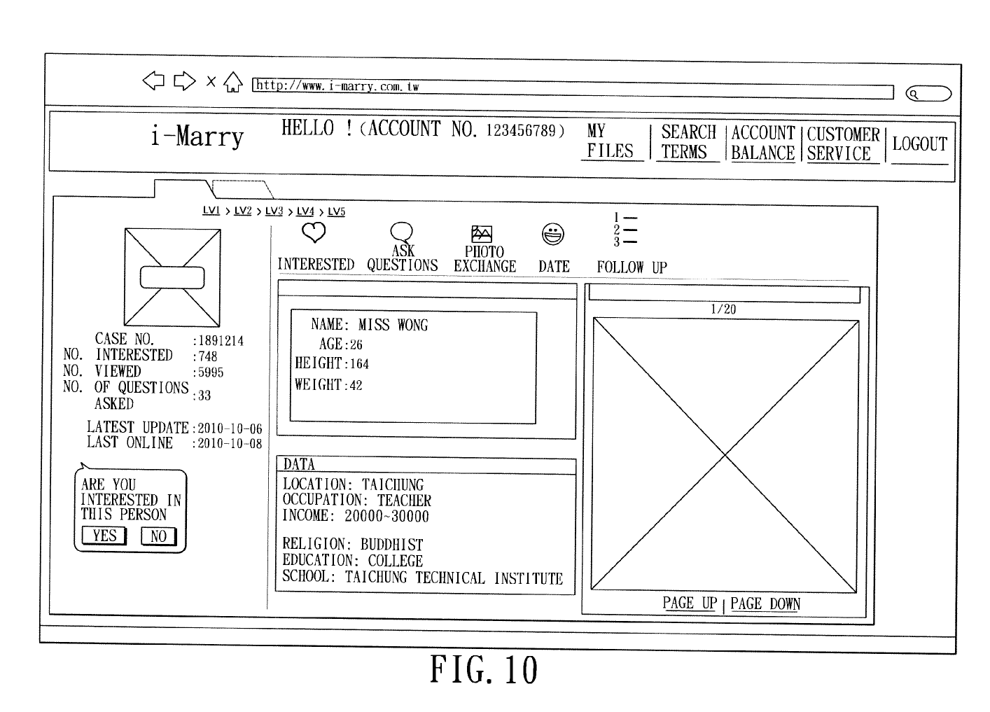

Step S6—after steps S5a S5b have been repeated a designated number (N1) of times, the relationship between the user 91 and the user 92 can be advanced. The interaction module 3 authorizes each of the users 91, 92 to see the photos of the other user 91, 92. The system 100 provides the interaction interface shown in FIG. 10, and returns to step S5a.

Step S7—after steps S5a S5b have proceeded for an additional designated number (N2) of times, the interaction module 3 instructs the scheduling module 4 to issue a dating invitation between the user 91 and the user 92.

Step S8—when the dating invitation has been accepted, the scheduling module 4 instructs the account management module 1 to subtract a predetermined number of points from the respective point balances of the user 91 and the user 92. The scheduling module 4 may optionally schedule the dating time and place.

Step S9—after the scheduled time for the date, the scheduling module 4 provides each of the users 91, 92 with a questionnaire. After confirming that the date took place as scheduled, the scheduling module 4 opens the message board between the user 91 and the user 92. If one of the users 91, 92 fails to appear at the scheduled date, the account management module 1 can restore the points subtracted from the point balance of the user 91, 92 who appeared. For the user 91, 92 who failed to appear, the account management module 1 can be configured to blacklist their account, provide a warning to other members, and restrict their dating scheduling privileges to protect other members.

In summary, the system 100 and method for online matchmaking management of this invention provides a more favorable service for those who intend to get married. Some aspects of this invention include receiving matching conditions of a user to quickly find candidate members, providing interaction between members through questionnaires to permit a potential couple to develop mutual understanding, and using conditional authorization for interaction between members as a mechanism to reduce dating costs.

While the present invention has been described in connection with what is considered the most practical and preferred embodiment, it is understood that this invention is not limited to the disclosed embodiment but is intended to cover various arrangements included within the spirit and scope of the broadest interpretation to encompass all such modifications and equivalent arrangements.

What is claimed is:

1. An online matchmaking management system comprising:
a member database for storing a plurality of member data files, each including basic data of a member;
an account management module connected to said member database and configured to process login data of a user;
a matching module connected to said member database and configured to receive a matching condition established by the user, and to select at least one candidate member from said member database that satisfies the matching condition; and
an interaction module connected to said matching module and configured to provide an interaction interface for the user to generate a marriage suitability questionnaire, to provide the marriage suitability questionnaire to a target member selected by the user from said at least one candidate member, to relay to the user a response of the target member to the marriage suitability questionnaire, and based on a number of interactions between the user and the target member, to provide the user with conditional authorization for further interaction with the target member.

2. The online matchmaking management system as claimed in claim 1, which is implemented using a server, said server being configured to connect with a respective electronic device of each of the user and the target member over a network.

3. The online matchmaking management system as claimed in claim 1, further comprising a marriage questionnaire database for storing a plurality of questions about marriage suitability, wherein the interaction interface provided by said interaction module includes a menu containing the questions about marriage suitability for selection by the user.

4. The online matchmaking management system as claimed in claim 3, wherein the interaction interface provided by said interaction module further includes a plurality of response fields corresponding respectively to the questions about marriage suitability for the user to fill in a user reply when the respective one of the questions is selected by the user, said user reply being provided to the target member when said interaction module receives from the target member a target member reply to the respective one of the questions.

5. The online matchmaking management system as claimed in claim 3, wherein said account management module is connected to said interaction module, each of said member data files including a point balance managed by said account management module, said account management module subtracting a predetermined number of points from said point balance of said member data file corresponding to the user upon receipt of an indication that the user wishes to be provided with the response of the target member to the questions selected by the user.

6. The online matchmaking management system as claimed in claim 5, further comprising a scheduling module connected to said interaction module, wherein when said interaction module determines that the number of interactions between the user and the target member reaches a predetermined number, said scheduling module issues a dating invitation for the user and the target member to go out on a date, and when the dating invitation is accepted by both the user and the target member, said scheduling module enables said account management module to subtract a number of points from the point balance of said member data file corresponding to at least one of the user and the target member.

7. The online matchmaking management system as claimed claim 1, further comprising a matching database for storing a plurality of matching files, each corresponding to a respective member;
wherein, when the user selects the target member from said at least one candidate member selected by said matching module, said matching module
presents the basic data of the target member to the user through said interaction module and asks the user whether the user is interested in the target member,
upon receipt of an indication of interest of the user in the target member, issues a notification to the target member of someone's interest and asks the target member whether the target member is interested in further interaction, and
upon receipt of an indication of the target member's interest in further interaction, records the target member in the matching file of the user, and instructs said interaction module to provide the interaction interface to the user.

8. The online matchmaking management system as claimed in claim 1, wherein, for each of the member data files, said account management module processes authentication of at least one of a mobile phone number, an email address, biometric information, an ID card, and an academic certificate.

9. A method of online matchmaking management comprising:
a) storing a plurality of member data files in a member database, wherein each of the member data files includes basic data of a member;
b) processing login data of a user;
c) receiving a matching condition established by the user, and selecting at least one candidate member from the member database that satisfies the matching condition;
d) using a server, providing an interaction interface for the user to generate a marriage suitability questionnaire, providing the marriage suitability questionnaire to a target member selected by the user from said at least one candidate member, and relaying to the user a response of the target member to the marriage suitability questionnaire; and
e) based on a number of interactions between the user and the target member, providing the user with conditional authorization for further interaction with the target member.

10. The method as claimed in claim 9, which is implemented using the server, the server being configured to connect with a respective electronic device of each of the user and the target member over a network.

11. The method as claimed in claim 9, wherein step a) further includes storing a plurality of questions about marriage suitability in a marriage questionnaire database, and the interaction interface provided in step d) includes a menu containing the questions about marriage suitability for selection by the user.

12. The method as claimed in claim 11, wherein the interaction interface provided in step d) further includes a plurality of response fields corresponding respectively to the questions about marriage suitability for the user to fill in a user reply when the respective one of the questions is selected by the user, the user reply being provided to the target member when a target member reply to the respective one of the questions is received from the target member.

13. The method as claimed in claim 11, wherein each of the member data files includes a point balance, and step d) includes subtracting a predetermined number of points from the point balance of the member data file corresponding to the user upon receipt of an indication that the user wishes to be provided with the response of the target member to the questions selected by the user.

14. The method as claimed in claim 13, wherein, in step e), when the number of interactions between the user and the target member reaches a predetermined number, a dating invitation for the user and the target member to go out on a date is issued, and when the dating invitation is accepted by both the user and the target member, a number of points is subtracted from the point balance of the member data file corresponding to at least one of the user and the target member.

15. The method as claimed in claim 9, wherein:
step a) further includes storing a plurality of matching files in a matching database, each of the matching files corresponding to a respective member;
said method further comprising, between steps c) and d), after the user selects the target member from said at least one candidate member,
presenting the basic data of the target member to the user and asking the user whether the user is interested in the target member,
upon receipt of an indication of interest of the user in the target member, issuing a notification to the target member of someone's interest and asking the target member whether the target member is interested in further interaction, and
upon receipt of an indication of the target member's interest in further interaction, recording the target member in the matching file of the user before providing the interaction interface to the user.

16. The method as claimed in claim 15, wherein, for each of the member data files, step a) further includes processing authentication of at least one of a mobile phone number, an email address, biometric information, an ID card, and an academic certificate.
